(19) United States
(12) Patent Application Publication
(10) Pub. No.: US 2015/0257127 A1
(43) Pub. Date: Sep. 10, 2015

(54) METHOD FOR SUPPORTING BEARER RESOURCE CONTROL

(71) Applicant: SAMSUNG ELECTRONICS CO., LTD., Gyeonggi-do (KR)

(72) Inventors: Liang Huarui, Beijing (CN); Lixiang Xu, Beijing (CN); Hong Wang, Beijing (CN)

(21) Appl. No.: 14/432,447

(22) PCT Filed: Sep. 30, 2013
(86) PCT No.: PCT/KR2013/008735

§ 371 Date: Mar. 30, 2015

(30) Foreign Application Priority Data
Sep. 29, 2012 (CN) 201210380293.1

(51) Int. Cl. H04W 72/00; H04W 4/06; H04W 4/00

(52) U.S. Cl. CPC H04W 72/005; H04W 4/005; H04W 4/06

(57) ABSTRACT

The present invention provides a method for supporting bearer resource control, used to assign Multimedia Broadcast Multicast Service (MBMS) bearer resource to a group service, comprising: assigning MBMS bearer resource to each group service according to group service information in a system; the group service information comprising the number of the group services in the system and service type information of the group services. By using the present invention, the MBMS bearer resources are assigned to the group services reasonably.

### TECHNICAL FIELD

The present invention relates to wireless communication technologies, and more particularly, to a method for supporting bearer resource control

### BACKGROUND ART

As shown in FIG. 1, a conventional network structure supporting Machine-Type Communication (MTC) is shown. In FIG. 1, an MTC-Interworking Function (MTC-IWF), a Services Capability Server (SCS) are network nodes newly defined. The MTC-IWF supports MTC functions and ensures interworking between a 3GPP network and MTC devices. The MTC-IWF has following functions:
as an endpoint of interfaces of T5 series, Tsp, S6mandRf/Ga;
authorizing the SCS before communicating with the 3GPP system;
authorizing a control plane request generated by the SCS;
supporting trigger functions of devices;
selecting a right device trigger mechanism;
protocol translation functions;
ensuring security communication between the 3GPP network and the SCS.

The SCS may provide services for terminals supporting MTC services. Usually, MTC applications are provided by an application server of an external network, and extra value-added services are provided by using the SCS. The SCS belongs to nodes of a MTC application network.

New service requirements are introduced by R-12, a concept of a MTC group is provided. Many MTC devices may form a group, and group members may receive the same message from a network side. All of the group members are located at a specific location area, and users outside the specific location area are not allowed to receive the messages.

### DISCLOSURE OF INVENTION

### Technical Problem

Currently, it is needed to optimizing resources of the network side as much as possible, since all of the group members receive the same message. Hence, a Multimedia Broadcast Multicast Service (MBMS) mechanism and a Cell Broadcast Service (CBS) mechanism are considered to be used. However, it is not provided that how to use the MBMS/CBS and how to optimize the resources of the network side.

### Solution to Problem

The present invention provides a method for supporting bearer resource control, so as to reasonably assign public MBMS bearer resources to group services.

The technology solutions provided by the present invention are as follows.

A method for supporting bearer resource control, used to assign public Multimedia Broadcast Multicast Service (MBMS) bearer resources to a group service, comprising: assigning public MBMS bearer resources to each group service according to group service information in a system; the group service information comprising the number of group services in the system and service type information of the group services.

The group service information further comprises type information of an access system corresponding to the group service; and

the public MBMS bearer resources are assigned to each group service according to the group service information and the number of services accessed by users via access systems of different types.

The group service information further comprises type information of an access system corresponding to the group service, the number of users accessing to access systems of different types, and the number of group services activated by each user.

The group service information is collected by a Machine-Type Communication-Interworking Function (MTC-IWF); and

the MTC-IWF assigns the public MBMS bearer resources to each group service according to the collected group service information.

The group service information is collected by a MTC-IWF; and the MTC-IWF sends the collected group service information to a Broadcast multicast service center (BM-SC); and

the BM-SC assigns the public MBMS bearer resources to each group service according to the received group service information.

The group service information is collected by a BM-SC; and the BM-SC assigns the public MBMS bearer resource to each group service according to the collected group service information.

As can be seen, according to a method for supporting bearer resource control provided by the present invention, public MBMS bearer resources are reasonably assigned to each group service according to group service information in the system.

### BRIEF DESCRIPTION OF DRAWINGS

FIG. 1 is a schematic diagram illustrating a structure of a conventional MTC system.

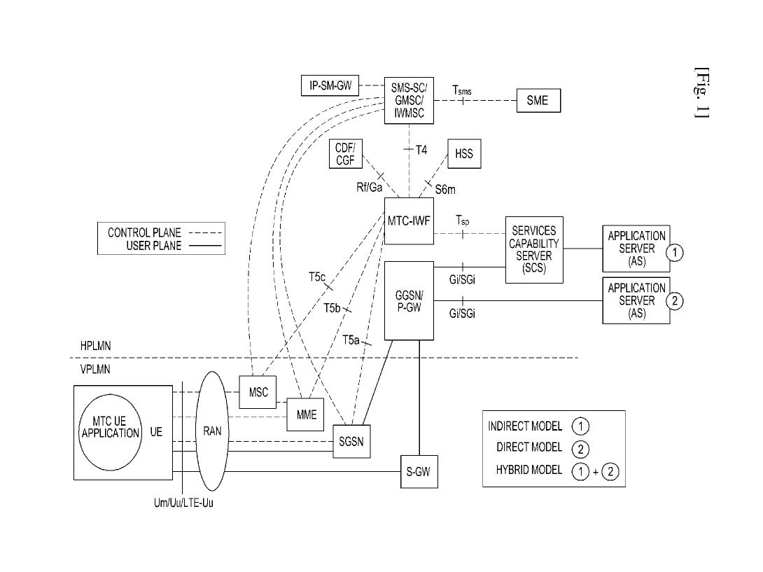

FIG. 2 is a schematic diagram illustrating a structure of a MTC system with a MBMS in accordance with a first example of the present invention.

FIG. 3 is a schematic flowchart illustrating a collecting process of a MTC-IWF in accordance with a second example of the present disclosure.

FIG. 4 is a schematic flowchart illustrating a MBMS session start process in accordance with a third example of the present disclosure.

FIG. 5 is a schematic flowchart illustrating a process of accessing a network by UE in accordance with a fourth example of the present disclosure.

FIG. 6 is a schematic diagram illustrating a structure of a MTC system with a MBMS in accordance with a sixth example of the present invention.

FIG. 7 is a schematic flowchart illustrating a process of accessing a network by UE in accordance with a seventh example of the present disclosure.

FIG. 8 is a schematic flowchart illustrating a process of accessing a network by UE in accordance with an eighth example of the present disclosure.

FIG. 9 is a schematic flowchart illustrating a MBMS session start process in accordance with a ninth example of the present disclosure.

### MODE FOR THE INVENTION

In order to make the purpose, solutions and merit more clear, the present disclosure is illustrated in detail hereinafter with reference to the accompanying drawings and specific examples.

A first embodiment is provided.

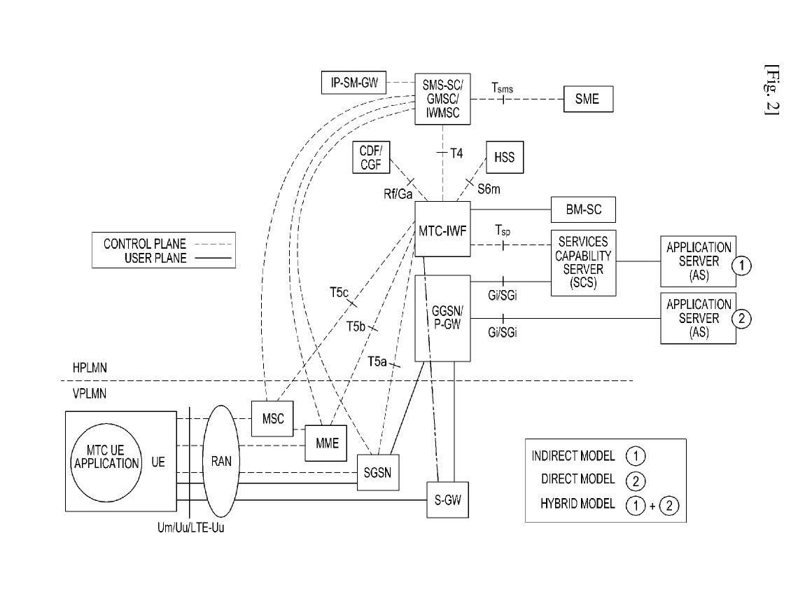

FIG. 2 is a schematic diagram illustrating a structure of a MTC system with a MBMS in accordance with a first example of the present invention.

A new interface is added between a Broadcast multicast service center (BM-SC) and a MTC-IWF. The interface supports establishing MBMS common bearer, and includes the following functions.
the MTC-IWF establishes MBMS common bearer and registers the MBMS common bearer in the BM-SC;
the BM-SC triggers a session start to the MTC-IWF.

The following new functions are added into the BM-SC.

A group service resources assigning and managing function is added: the BM-SC may assign resources to different group services according to currently activated group services. The BM-SC may perform assignment according to an access system corresponding to the group service, or according to the number of users corresponding to the group service, or according to the number of services.

Note: the BM-SC is controlled by the 3GPP system or a third-party MTC provider.

The following new functions are added to the MTC-IWF to support the MBMS:

collecting functions for services and access systems;

storing Radio Access Technology (RAT) information accessed by current group users and corresponding service type information;

storing a relation between the current activated group services and group users;

supporting MBMS optimization function: the MTC-IWF may reduce MBMS signaling not need to be sent according to the RAT information according to the users currently accessed;

a group service resources assigning and managing function: the MTC-IWF may assign resources to different group services according to currently activated group services. The MTC-IWF may perform assignment according to an accessed system corresponding to the group service, or according to the number of users corresponding to the group service, or according to the number of services.

A new interface of a control plane is added between the MTC-IWF and a Serving Gateway (S-GW), the new interface has the following function:
a protocol stack of the interface supports a GTP-C protocol stack.

A second embodiment is provided.

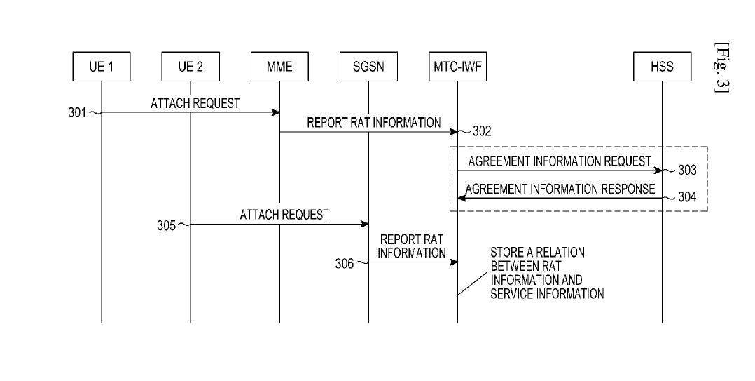

FIG. 3 is a schematic flowchart illustrating a collecting process of a MTC-IWF, so as to determine whether a terminal has accessed to different access systems corresponding to a current service, i.e. the group service.

In block 301, UE1 generates an attach request, and sends the attach request to an MME.

In block 302, the MME sends report information via an interface between the MME and the MTC-IWF. The report information includes RAT information corresponding to the current MME, service information of a service requested by the current UE, or UE ID. The UE ID is an IMSI, or other information indicating the ID of the UE, e.g. MISISDN, or other identifiers. The UE ID is optional in the report information.

In block 303, The MTC-IWF sends an agreement information request to a HSS to request agreement information related to the UE.

If in block 302 the UE ID and the service information of the service requested by the UE are included, the block 303 is to request the HSS to determine whether the current UE belongs to group users and whether the service requested by the UE is a group service.

If in block 302 the service information of the service requested by the UE is included, the block 303 is to inquire via HSS by the MTC-IWF whether the service requested by the UE is a group service.

In block 304, the HSS sends an agreement information response to the MTC-IWF according to the agreement information request in block 303. The agreement information response includes a group identifier of the UE and group service information of the UE. For example, the group service information includes an ID of a group member, whether the group member supports the group service, and information of the group identifier. If the group service is used to identify the group identifier, the parameter of the group identifier is cancelled.

*Blocks 303-304 may be performed before block 301, e.g. the MTC-IWF may obtain the agreement information related to the UE in other procedure.

In this case, according to the obtained information, the MTC-IWF may obtain whether the RAT is accessed by the user currently and whether the group service is accessed by the user in the RAT currently. The MTC-IWF stores the RAT information and the information corresponding to the group service according to the obtained information.

In block 305, if the user performs the access via a UMTS network, the UE sends an attach request information to the SGSN.

In block 306, the SGSN sends the RAT information to the MTC-IWF, the RAT information is the same as that in block 302.

Afterwards, blocks 303-304 may be performed repeatedly, the MTC-IWF stores the RAT information and the information corresponding to the group service according to the obtained information.

For the purpose of supporting this procedure, the following functions are added to a T5a/b/c interface:

the MME/SGSN/MSC needs to report the RAT type information supporting the group services currently to the MTC-IWF.

In this procedure, the UE may perform the access via the MME and the SGSN, in other procedure, the UE may perform the access via the MSC by using the above procedure. According to obtained information, the IWF stores accessed service information and activates the RAT information accessed by the UE of the service.

A third embodiment is provided.

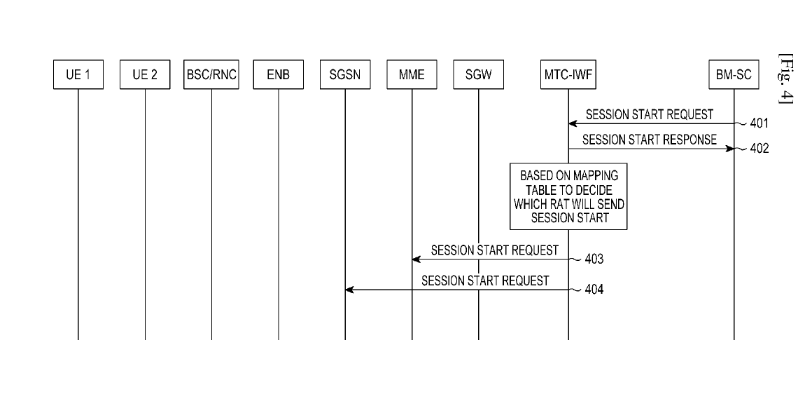

FIG. 4 is a schematic flowchart illustrating a MBMS session start process in accordance with a third example of the present disclosure.

In block 401, the BM-SC sends a session start request to the MTC-IWF. The session start request includes a group identifier, broadcast service area information, QoS parameter. The group identifier may be a TMGI, an APN, or group identifier information newly defined, e.g. group ID which includes a name of a network or domain name information; or location information, e.g. conventional cell identifier information (ECGI), a LAI, or a TAI. The location area scope corresponding to the group identifier or the broadcast area scope is decided by the BM-SC based on the following factors.

A), the location area scope corresponding to the group service, e.g. the location area scope corresponding to the current group service configured by the system is the LAI, the TAI, or a certain cell ID.

B), the BM-SC may collect reports sent by different UEs when they accessing the system. As shown in FIG. 3, the information reported to the MTC-IWF via the MME when the current UE accesses the system includes the requested group service and current location information; or an OAM server in an operator system may collect the location area scopes and the terminal data amount of the group services requested currently, determines the number of terminals corresponding to a certain group service and the location area. The BM-SC may obtain the location area scope according to the MTC-IWF or via the OAM server.

C), the MTC-IWF may obtain the location area scope needed to be broadcasted according to the service area scope of the group service in the subscription information. The location area scope corresponding to the group service may be informed to the BM-SC by the MTC-IWF via an interface message between the MTC-IWF and the BM-SC. Or the MTC-IWF reports the location area scope to the OAM server, and the BM-SC obtains the location area information corresponding to the group service via the OAM server.

The message may also include RAT information for sending broadcast messages.

In block 402, the MTC-IWF sends a session start response to the BM-SC.

In block 403, the MTC-IWF obtains collects the RAT information corresponding to the group services, e.g. the number of RAT with activated group services. The MTC-IWF decides a RAT according to the RAT information corresponding to the obtained group service, and decides a network node of the RAT. For example, if the group services are requested by the users in only LTE and GPRS networks, the MTC-IWF sends the session start request only to the MME and the SGSN.

In block 404, the IWF sends the session start request to the SGSN according to the obtained RAT information corresponding to the group services.

A fourth embodiment is provided.

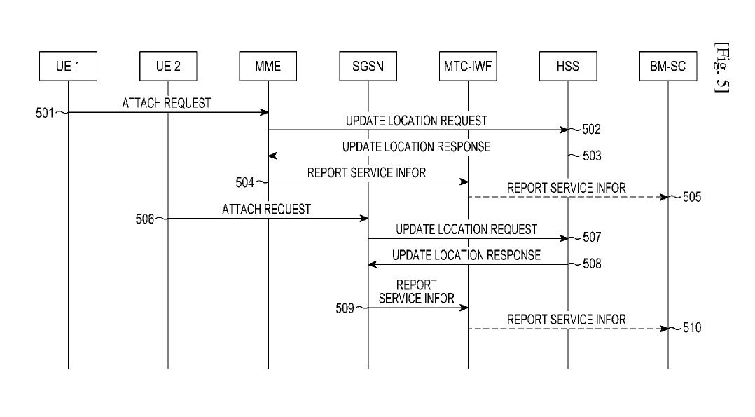

FIG. 5 is a schematic flowchart illustrating a process of accessing a network by UE in accordance with a fourth example of the present disclosure.

In block 501, UE1 sends an attach request, and the attach request is sent to an MME via a LTE network. The attach request includes service information of a service requested by the UE, e.g. APN information or a group service identifier.

In block 502, the MME sends an update location request to a HSS to request the HSS to provide agreement information of the UE.

In block 503, the HSS sends an update location response to provide the agreement information of the UE.

In block 504, the MME determines whether to activate the group service for the UE according to the service information requested by the UE and the agreement information of the UE, if yes, the MME sends report service information (infor) to the MTC-IWF. The report service infor includes information of group services activated currently, the information may be APN information, group identifier information or IP address information that make the MTC-IWF identify the service. The MTC-IWF may determine the number of group services activated currently according to the obtained service information. Each of the groups may correspond to one group service or correspond to multiple group services. The IWF may assign resources according to the determined number of group services and service type information of each group service. Detailed assignment principle includes a first assignment principle in the fifth embodiment.

Further, besides the information of the services to be activated currently, the information also includes information of the RAT currently accessed by the UE, or includes the ID of the UE.

The MTC-IWF may collect information of the RAT corresponding to each group service according to the received information of accessed RAT corresponding to all service information and data of the UE. The MTC-IWF may assign resources according to the collected information and strategy information of operator obtained via the OAM. Detailed assignment principle includes a second assignment principle in the fifth embodiment.

Or, the MTC-IWF may collect information of the RAT corresponding to each group service, the number of users accessed to the service of each RAT, and the number of activated group services of each user. The IWF may assign resources according to the collected information. Detailed assignment principle includes a third assignment principle in the fifth embodiment.

In block 505, the MTC-IWF sends the received service information to the BM-SC, and the BM-SC assigns resources according to the service information. The contents of the reported message are the same with that in block 504, and thus the functions of the MTC-IWF described in block 504 are implemented in the BM-SC. Or, the message may carry the resource assignment performed by the MTC-IWF in block 504, and sends resource assignment parameters to the BM-SC. The BM-SC assigns the resources to all the accessed services uniformly according to the resources assigned by the MTC-IWF.

Blocks 506-510 are the same with blocks 501-505, in which the UE access the network via other access system. In the embodiment, the network is accessed via the GPRS network.

A fifth embodiment is provided.

As shown in fourth embodiment, public MBMS bearer resources are between the MTC-IWF and BM-SC, the sum of bearer resources in the system is indicated as “MBMS APN-AMBR sum” in the embodiments of the present invention, the resources assigned by the MTC-IWF or BM-SC to each service is indicated as “MBMS APN-AMBRi”. For the purpose of effectively managing public MBMS bearer resource and assigning resources more reasonably to each service, assignment principles are provided in the embodiments of the present invention:

$$MBMS APN - AMBR sum = {\sum }_{i = 1}^{i = N} MBMS APN - {AMBR}_{i}$$

If the MTC-IWF determines that three group services are activated currently, MBMS APN−AMBR sum=MBMS APN−AMBR1+MBMS APN−AMBR2+MBMS APN−AMBR3, and the sum of the bearer resources are assigned to each group service as following.

The first assignment principle is provided.

The MTC-IWF assigns resources according to the number of group services and service type information of each group service. For example, the system currently includes 3 group services: service 1, service 2 and service 3. Herein, service 1 is a data service, service 2 is an audio service and service 3 is a video service. Based on the service types of the group services, the video service needs more data amount, and the data service needs less data amount, the MTC-IWF assigns more resources to service 3 and assigns less resources to service 1.

The second assignment principle is provided.

The MTC-IWF may assign resources according to the RAT information corresponding to each current service. For example, services 1 and 2 are accessed via LTE, and service 3 is accessed via UMTS. The MTC-IWF obtains the strategy information of the operator via the OAM, e.g. services with large amount of data are accessed via the LTE as much as possible, and more resources are assigned to services 1 and 2 according to the types of the services 1 and 2. For example, when the operator determines the LTE system has relatively large service amount accessed by the users, the MTC-IWF assigns more resources to the group services corresponding to the LTE system. For another example, service 1 is accessed via the LTE or the UMTS, service 2 is accessed via the UMTS, when the operator determines the LTE system has relatively large service amount accessed by the users, the MTC-IWF assigns more resources to service 1.

The third assignment principle:

the MTC-IWF may assign resources further according to the currently determined number of users accessed to different RATs and the number of services activated for the current user.

Further, in the above procedure, the MTC-IWF may send resource information assigned to the MBMS APN-AMBR to a PDN Gateway (P-GW)/GGSN via the OAM or SCS, so that the P-GW/GGSN may assign other resources to other services (APN-AMBR) according to the resource information assigned to the MBMS APN-AMBR.

Or, further in the above procedure, the MTC-IWF may decide resources assigned to the MBMS APN-AMBR according to other resource information assigned by the P-GW. The MTC-IWF performs resource assignment according to the resource assignment information sent by the P-GW to the OAM or the resource assignment information sent by other nodes, or the P-GW sends assigned information to the SCS, and the SCS sends the assigned information to the MTC-IWF.

Table 1 shows MBMS context information supporting the GPRS system.

TABLE 1

| Parameter | Description | RAN | SGSN | GGSN | BM-SC | MTC-IWF |
|---|---|---|---|---|---|---|
| Multicast/ | MBMS bearer service in broadcast | X | X | X | X | |
| broadcast mode | or multicast mode | | | | | |
| IP multicast | IP multicast address identifying | X | X | X | X | |
| address(multi- | the MBMS bearer described by | | | | | |
| castmodeonly) | this MBMS Bearer Context. | | | | | |
| APN(multicast- | Access Point Name on which this | X | X | X | X | |
| modeonly) | IP multicast address is defined. | | | | | |
| TMGI | Temporary Mobile Group Identity | X | X | X | X | |
| | allocated to the MBMS bearer | | | | | |
| | service. | | | | | |
| Group identifier | ID information supporting MTC | X | X | X | X | X |
| | group identifier | | | | | |
| Flow Identifier | Location dependent subflow of the | | X(note 1) | X(note 1) | X(note 1) | |
| (broadcast mode | MBMS bearer service. When | | | | | |
| only) | present, the Flow Identifier | | | | | |
| | together with the TMGI uniquely | | | | | |
| | identify the MBMS Bearer | | | | | |
| | Context. | | | | | |
| GGSN TEID-C | Tunnel Endpoint Identifier of | | X | | | |
| | GGSN for control plane. | | | | | |
| GGSN IP | The IP address of the GGSN used | | X(note 4) | | | |
| Address for | for the control plane. | | | | | |
| Control Plane | | | | | | |
| in use | | | | | | |
| State | State of bearer plane resources | X | X | X | X | |
| | (‘standby’ or ‘active’) | | | | | |
| Required | Minimum bearer capabilities the | | X | X | X | |
| MBMS Bearer | UE needs to support | | | | | |
| Capabilities | | | | | | |
| (multicastmodeonly) | | | | | | |
| QoS | Quality of Service required for the | X | X | X | X | |
| | MBMS bearer service | | | | | |
| Group QoS | QoS needed by MBMS group | | | X | X | X |
| | bearer | | | | | |
| MBMS Service | Area over which the MBMS bearer | X | X | X | X | |
| Area | service has to be distributed. | | | | | |
| List of | List of downstream nodes that | | X(note 5) | X(notes 3, 4, 6) | X | |
| downstream | have requested the MBMS bearer | | | | | |
| nodes | service and to which notifications | | | | | |
| | and MBMS data have to be forwarded. | | | | | |
| Number of UEs | Number of UEs hosted by the node | | X | X | | |
| (multicast- | that have joined the multicast | | | | | |
| modeonly) | MBMS bearer service. | | | | | |
| List of PMM- | List of PMM-CONNECTED UEs | X²⁾ | | | | |
| CONNECTED UEs | which have activated an MBMS | | | | | |
| | service. | | | | | |
| List of RAs | List of RAs, each of which | X¹⁾ | X¹⁾ | | | |
| (multicast- | contains at least one UE that has | | | | | |
| modeonly) | joined the MBMS bearer service. | | | | | |
| IP multicast and | IP addresses identifying the SSM | X | X | X | | |
| Source address | channel used for user plane dis- | | | | | |
| for distribution | tribution on the backbone network | | | | | |
| MBMS HC | Flag set by BM-SC if it is using | | X | X | X | |
| indicator | compressed header for the | | | | | |
| | payload. | | | | | |

(note 1)It is an optional parameter.
(note 2)It is available only for UTRAN, not for GERAN.
(note 3)For GGSN, the list at least includes the couples of the SGSN IP addresses and TEIDs for control plane, and the couples for user plane.
(note 4)GSN that supports both IPv4 and IPv6 address types, stores only the IP address in use.
(note 5)For SGSN, the list includes the registered DRNC.
(note 6)The GGSN shall include SGSN Address for user data and TEID-U for downstream SGSNs that do not accept the IP multicast backbone distribution.

Table 2 shows MBMS context information supporting the LTE system.

TABLE 2

| | | | MME/ | MBMS- | | MTC- |
|---|---|---|---|---|---|---|
| Parameter | Description | RAN | SGSN | GW | BM-SC | IIIWF |
| MBMS GW | Tunnel Endpoint Identifier of | | X | | | |
| TEID-C | MBMS GW for control plane. | | | | | |
| TMGI | Temporary Mobile Group Identity | X | X | X | X | |
| | allocated to the MBMS bearer | | | | | |
| | service. | | | | | |
| Group | ID information supporting | X | X | X | X | X |
| identifier | MTC group identifier | | | | | |
| Flow | Location dependent subflow of | | X*(note 1) | X(note 1) | X(note 1) | |
| Identifier | the MBMS bearer service. When | | | | | |
| | present, the Flow Identifier | | | | | |
| | together with the TMGI uniquely | | | | | |
| | identify the MBMS Bearer Context. | | | | | |
| MBMS GW | The IP address of the MBMS | | X(note 2) | | | |
| IP Address | GW used for the control | | | | | |
| for Control | plane. | | | | | |
| Plane in | | | | | | |
| use | | | | | | |
| MBMS GW | The IP address of the MBMS | | X(note 2) | | | |
| IP Address | GW used for the user plane. | | | | | |
| for User | | | | | | |
| Plane in | | | | | | |
| use | | | | | | |
| C-TEID | Common Tunnel Endpoint Identifier | X | | X | | |
| | of MBMS GW for user plane | | | | | |
| QoS | Quality of Service required for | X | X | X | X | |
| parameters | the MBMS bearer service. | | | | | |
| Group | Quality of Service required for | | | X | X | X |
| Qos | the MBMS bearer service | | | | | |
| MBMS | Area over which the MBMS bearer | X | X | X | X | |
| Service | service has to be distributed. | | | | | |
| Area | | | | | | |
| List of | List of downstream nodes that have | | X(note 3) | X(note 4) | X | |
| downstream | requested the MBMS bearer service | | | | | |
| nodes | and to which notifications have | | | | | |
| | to be forwarded. | | | | | |
| IP multicast | IP addresses identifying the SSM | X | X | X | | |
| address and | channel used for user plane | | | | | |
| IP Source | distribution on the backbone | | | | | |
| address for | network. | | | | | |
| distribution | | | | | | |
| MBMS HC | Flag set by BM-SC if it is using | | X(note 5) | | X(note 5) | |
| indicator | compressed header for the payload. | | | | | |
| SGSN IP | The IP address and TEID of SGSN used | | | X | | |
| Address | for the user plane over Sn-U when | | | | | |
| and TEID | some RNCs have not accepted IP | | | | | |
| for User | multicast distribution. | | | | | |
| Plane over | | | | | | |
| Sn-U | | | | | | |

(note 1)It is an optional parameter.
(note 2)MBMS GW that supports both IPv4 and IPv6 address types, stores only the IP address in use.
(note 3)For SGSN, the list includes the registered DRNC.
(note 4)For MBMS GW, the list includes the couples of the SGSNs and MMEs IP addresses and TEIDs for control plane.
(note 5)Header Compression is only supported for UTRAN for this Release.

A sixth embodiment is provided.

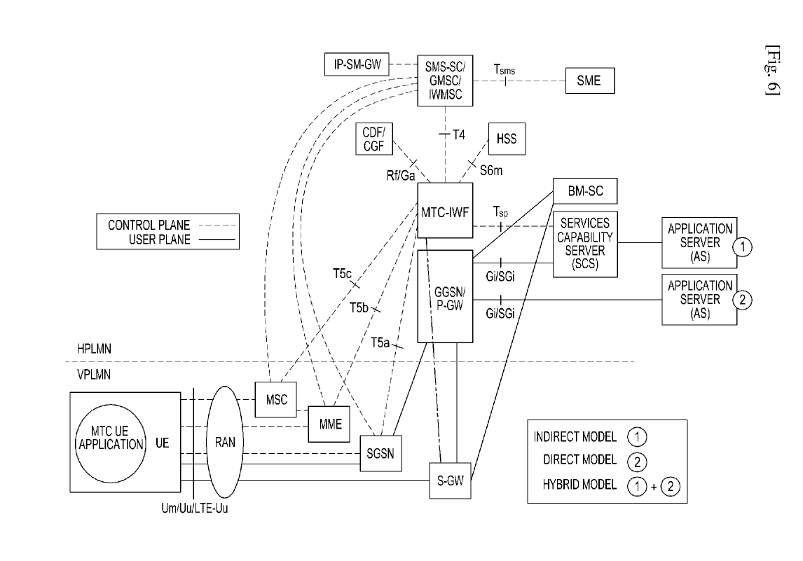

FIG. 6 is a schematic diagram illustrating a structure of a MTC with a MBMS in accordance with a sixth example of the present invention. The MBMS public bearer is between the BM-SC and the GGSN or is between the BM-SC and the S-GW. The structure shown in FIG. 6 is taken as an example.

The following functions are added to the BM-SC:

collecting functions for services and access systems;

storing RAT information accessed by current group users and corresponding service type information;

storing a relation between the current activated group services and group users.

supporting MBMS optimization function: the MTC-IWF may reduce MBMS signaling not need to be sent according to the information of RAT accessed by the users currently;

a group service resources assigning and managing function: the BM-SC may assign resources to different group services according to currently activated group services. The BM-SC may perform assignment according to an accessed system corresponding to the group service, or according to the number of users corresponding to the group service, or according to the number of services.

The following functions are added to the MTC-IWF:

collecting functions for services and access systems;

storing RAT information accessed by current group users and corresponding service type information;

storing a relation between the current activated group services and group users;

a group service resources assigning and managing function: the BM-SC may assign resources to different group services according to currently activated group services. The BM-SC may perform assignment according to an accessed system corresponding to the group service, or according to the number of users corresponding to the group service, or according to the number of services.

According to the structure in the embodiment, the bearer resource assignment principle is the same as that in the fifth embodiment, and the difference only lies in different entities implement the bearer resources, specifically, the mode for implementing the bearer resources includes the following.

The BM-SC performs resource statistics according to received service type information, assigns resources according to the number of services currently activated. For example, the system currently includes 3 group services, then MBMS APN−AMBR sum=MBMS APN−AMBR1+MBMS APN−AMBR2+MBMS APN−AMBR3.

The BM-SC assigns resources according to the number of group services and service type information of each group service. For example, the system currently includes 3 group services: service 1, service 2 and service 3. Herein, service 1 is a data service, service 2 is an audio service and service 3 is a video service. Based on the service types of the group services, the BM-SC assigns more resources to service 3 and assigns less resources to service 1.

The BM-SC may assign resources according to the RAT information corresponding to each current service. For example, services 1 and 2 are accessed via LTE, and service 3 is accessed via UMTS. The BM-SC obtains the strategy information of the operator via the OAM, e.g. services with large amount of data are accessed via the LTE as much as possible, and more resources are assigned to services 1 and 2 according to the types of the services 1 and 2. For example, when the operator determines the LTE system has relatively large service amount accessed by the users, the BM-SC assigns more resources to the group services corresponding to the LTE system. For another example, service 1 is accessed via the LTE or the UMTS, service 2 is accessed via the UMTS, when the operator determines the LTE system has relatively large service amount accessed by the users, the BM-SC assigns more resources to service 1. Or, the BM-SC may assign resources further according to the currently determined number of users accessed to different RATs and the number of services activated for the current user.

Further, in the above procedure, the BM-SC may send resource information assigned to the MBMS APN-AMBR to the P-GW/GGSN, so that the P-GW/GGSN may assign other resources to other services (APN-AMBR) according to the resource information assigned to the MBMS APN-AMBR.

Or, further in the above procedure, the BM-SC may decide resources assigned to the MBMS APN-AMBR according to other resource information assigned by the P-GW.A seventh embodiment is provided.

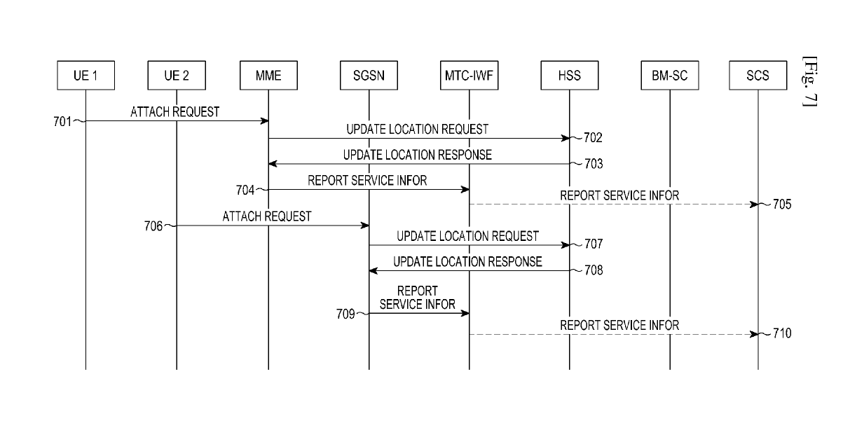

FIG. 7 is a schematic flowchart illustrating a process of accessing a network by UE in accordance with a seventh example of the present disclosure.

Blocks 701-703 are the same with blocks 501-505.

In block 704, the MME sends service information to the MTC-IWF. The service information includes RAT type, e.g. type information of an access network corresponding to the current MME. In this case, according to the obtained information, the MTC-IWF may determine whether there is a user accessed the current RAT and whether there is a user accessed the group service of the current RAT.

Further, the service information may include ID information of the UE, e.g. an IMSI or a MISISDN. The UE ID is optional. The service information may include current service information, e.g. the MME determining to activate the group service for the UE, the MME reporting the information of the currently activated group service to the MTC-IWF, the information may be APN or specific service identifier information. The MTC-IWF stores a relation between the RAT information and service information. Further, The MTC-IWF may determine the number of group services activated currently according to the obtained service information. Each of the groups may correspond to one group service or correspond to multiple group services. The MTC-IWF may assign resources according to the determined number of group services. Detailed assignment principles are described in the fifth embodiment.

In block 705, the MTC-IWF may forward the service report message sent by the MME to the SCS. Because the SCS and the BM-SC may be implemented via the same physical entity, the BM-SC may obtain the relation between the RAT types and the services via internal forwarding of the SCS device.

The BM-SC obtains the service information via internal forwarding of the SCS device. The BM-SC may determine the number of group services activated currently according to the obtained service information. Each of the groups may correspond to one group service or correspond to multiple group services. The BM-SC may assign resources according to the determined number of group services. Detailed assignment principles are described in the fifth embodiment.

It should be noted that, the function of determining the number of group services may be implemented in the IWF or the BM-SC. If the function is implemented in the BM-SC, the service information is sent to the BM-SC via block 705.

The IWF may send the information to the OAM server, and then the OAM server sends the information to the BM-SC.

Blocks 706-710 are the same with blocks 701-705, which indicates a procedure of accessing via GPRS system by the UE.

An eighth embodiment is provided.

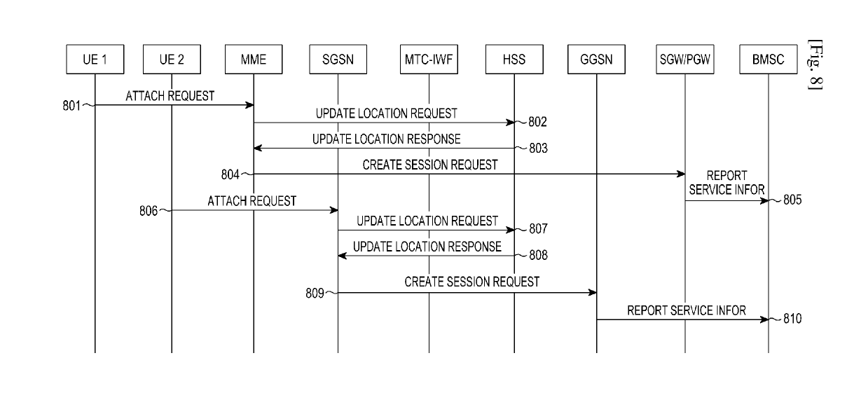

The eighth embodiment is an alternative of the seventh embodiment. FIG. 8 is a schematic flowchart illustrating a process of accessing a network by UE in accordance with an eighth example of the present disclosure.

Blocks 801-803 are the same with blocks 701-703,

In block 804, the MME sends a create session request to the S-GW/P-GW, the create session request carries type information of a RAT accessed by the UE currently and service information currently activated for the UE by the MME.

In block 804, the P-GW sends report service infor to the BM-SC. The report service infor includes RAT information corresponding to activated services. The BM-SC may determine a core network device node to which the MBMS session message is to be sent, according to the received relation between the services and the RAT types. Detailed start procedure of the MBMS session is described in the ninth embodiment.

Further, the message may also include group identifier. The BM-SC may determine the number of group services activated currently according to the received service information. Each of the groups may correspond to one group service or correspond to multiple group services. The BM-SC may assign resources according to the determined number of group services. Detailed assignment principles are described in the fifth embodiment.

Blocks 806-810 are the same with blocks 801-805, which indicates the accessing of the UE2 via the GPRS network.

A ninth embodiment is provided.

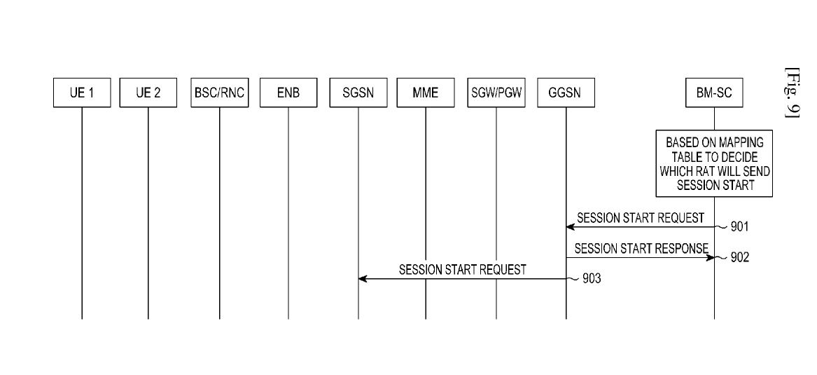

FIG. 9 is a schematic flowchart illustrating a MBMS session start process in accordance with a ninth example of the present disclosure.

*In block 901, The BM-SC may determine a system to which the session start request is to be sent according to the stored relation between the RAT types and services. If only the users of the GPRS system access the group service currently, the BM-SC may send the session start request to the GPRS system only. The BM-SC sends the session start request to the GGSN.

The session start request includes a group identifier, broadcast service area information, QoS parameter. The group identifier may be a TMGI, an APN, or group identifier information newly defined, e.g. group ID which includes a name of a network or domain name information; or location information, e.g. conventional cell identifier information (ECGI), a LAI, or a TAI. The location area scope corresponding to the group identifier or the broadcast area scope is decided by the BM-SC based on the following factors.

A), the location area scope corresponding to the group service, e.g. the location area scope corresponding to the current group service configured by the system is the LAI, the TAI, or a certain cell ID.

B), the BM-SC may collect reports sent by different UEs when accessing the system. As shown in FIG. 3, the information reported to the MTC-IWF via the MME when the current UE accesses the system includes the requested group services and current location information; or an OAM server in an operator system may collect the location area scopes and the terminal data amount of the group services requested currently, determines the number of terminals corresponding to a certain group service and the location area. The BM-SC may obtain the location area scope according to the MTC-IWF or via the OAM server.

C), the MTC-IWF may obtain the location area scope needed to be broadcasted according to the service area scope of the group service in the subscription information. The location area scope corresponding to the group service may be informed to the BM-SC by the MTC-IWF via an interface message between the MTC-IWF and the BM-SC. Or the MTC-IWF reports the location area scope to the OAM server, and the BM-SC obtains the location area information corresponding to the group service via the OAM server.

The message may also include RAT information for sending broadcast messages.

In block 902, the GGSN sends a session start response to the BM-SC.

In block 903, the GGSN sends a session start request to the SGSN.

The foregoing are only preferred examples of the present disclosure and are not for use in limiting the protection scope of the present disclosure. Any modification, equivalent replacement and improvement made within the scope of the present disclosure should be covered under the protection scope of the present disclosure.

1. A method to support bearer resource control used to assign Multimedia Broadcast Multicast Service (MBMS) bearer resources to a group service, the method comprising:
collecting, by an entity, group service information comprising a number of group services and a service type for each group service; and
assigning, by the entity, MBMS bearer resources to each group service according to the collected group service information.

2. The method of claim 1, wherein the group service information further comprises type information of an access system corresponding to each group service, and wherein the MBMS bearer resources are assigned to each group service according to the group service information and the number of group services that are accessed by one or more users via access systems of one or more types.

3. The method of claim 1, wherein the group service information further comprises type information of an access system corresponding to each group service, a number of users accessing access systems of one or more types, and a number of group services activated by each user.

4. The method of claim 1, further comprising collecting, by a Machine-Type Communication Interworking Function (MTC-IWF), the group service information, and assigning, by the MTC-IWF, the MBMS bearer resources to each group service according to the collected group service information.

5. The method of claim 1, further comprising collecting, by an MTC-IWF, the group service information, sending, by the MTC-IWF, the collected group service information to a Broadcast multicast service center (BM-SC), and assigning, by the BM-SC, the MBMS bearer resources to each group service according to the received group service info illation.

6. The method of claim 1, further comprising collecting, by an BM-SC, the group service information, and assigning, by the BM-SC, the MBMS bearer resource to each group service according to the collected group service information.

7. The method of claim 2, further comprising collecting, by an MTC-IWF, the group service information, and assigning, by the MTC-IWF, the MBMS bearer resources to each group service according to the collected group service information.

8. The method of claim 3, further comprising collecting, by an MTC-IWF, the group service information, and assigning, by the MTC-IWF, the MBMS bearer resources to each group service according to the collected group service information.

9. The method of claim 2, further comprising collecting, by an MTC-IWF, the group service information, sending, by the MTC-IWF, the collected group service information to a Broadcast multicast service center (BM-SC), and assigning, by the BM-SC, the MBMS bearer resources to each group service according to the received group service information.

10. The method of claim 2, further comprising collecting, by an BM-SC, the group service information, and assigning, by the BM-SC, the MBMS bearer resource to each group service according to the collected group service information.

11. A system to support bearer resource control used to assign Multimedia Broadcast Multicast Service (MBMS) bearer resources to a group service, the system comprising:
an apparatus configured to:
collect group service information comprising a number of group services and a service type for each group service, and
assign MBMS bearer resources to each group service according to the collected group service information.

12. The system of claim 11, wherein the group service information further comprises type information of an access system corresponding to each group service, and wherein the MBMS bearer resources are assigned to each group service according to the group service information and the number of group services that are accessed by one or more users via access systems of one or more types.

13. The system of claim 11, wherein the group service information further comprises type information of an access system corresponding to each group service, a number of users accessing access systems of one or more types, and a number of group services activated by each user.

14. The system of claim 11, further comprising a Machine-Type Communication Interworking Function (MTC-IWF) configured to collect the group service information, and assign the MBMS bearer resources to each group service according to the collected group service information.

15. The system of claim 11, further comprising an MTC-IWF configured to collect the group service information; send the collected group service information to a Broadcast multicast service center (BM-SC); and assign the MBMS bearer resources to each group service according to the received group service information.

16. The system of claim 11, further comprising an BM-SC configured to collect the group service information; and assign the MBMS bearer resource to each group service according to the collected group service information.

17. The system of claim 12, further comprising an MTC-IWF configured to collect the group service information, and assign the MBMS bearer resources to each group service according to the collected group service information.

18. The system of claim 13, further comprising an MTC-IWF configured to collect the group service information, and assign the MBMS bearer resources to each group service according to the collected group service information.

19. The system of claim 12, further comprising an MTC-IWF configured to collect the group service information; send the collected group service information to a Broadcast multicast service center (BM-SC); and assign the MBMS bearer resources to each group service according to the received group service information.

20. The method of claim 12, further comprising an BM-SC configured to collect the group service information; and assign the MBMS bearer resource to each group service according to the collected group service information.
